(19) United States
(12) Patent Application Publication
(10) Pub. No.: US 2011/0011995 A1
(43) Pub. Date: Jan. 20, 2011

(54) BRACKET FOR THE EQUIPMENT OF A ROLLING CART, PARTICULARLY A SHOPPING CART

(75) Inventor: Hubert Tridon De Rey, Le Perreux Sur Marne (FR)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ITOU, Montreuil (FR)

(21) Appl. No.: 12/866,057

(22) PCT Filed: Feb. 2, 2009
(86) PCT No.: PCT/FR2009/050147

§ 371 Date: Sep. 14, 2010

(30) Foreign Application Priority Data
Feb. 4, 2008 (FR) 0850678

(51) Int. Cl. F16M 13/02

(52) U.S. Cl. 248/214

(57) ABSTRACT

The invention relates to a bracket (30) of the type that comprises a transverse platen (36) extending in the vicinity of the handle bar (12) of the cart, and two flanges (40) for bearing and attaching the bracket (30), characterised in that each side flange (40) includes a housing (44) that has a shape complementary to the outer outline of the associated part (13) for assembling the handle bar (12) and is open transversally towards the inside, and a plate (54) for closing the housing, that can be attached to the side flange (40) in order to enclose the assembling part (13) transversally in the housing (44) and to immobilise the side flange (40) on the assembling part (13).

The present invention concerns a bracket equipping a rolling cart, such as a cart used in a supermarket or railroad station, or even an airport, and which notably constitutes an advertising display.

A rolling cart intended for self-service store customers enables its users to accommodate various articles and objects collected at the store in the course of his/her purchases. Such a rolling cart contains an upper basket which, for example, consists of a wire frame, the cart being mounted on a lower chassis.

Each of the two opposite vertical side walls of the cart and its basket is extended at its upper rear end by an upright (shaft) which extends globally upward and backward.

The cart thus contains two lateral uprights between which there is a cylindrical transverse horizontal bar of circular section, also called a grip, which enables the user standing behind the cart to maneuver the cart.

The handle bar is generally a tubular member attached between the two uprights.

In the case of a wire cart, each upright essentially consists of a reversed U-folded wire.

The attachment of the tubular grip on the upper end formed by a U-shaped wire arch calls, for example, for a molded plastic assembly part in the form of a sleeve, presenting a groove having a reversed U-shaped outline, which receives the upper part of the corresponding upright, the upper center zone at the rear end of that assembly part bearing a horizontal transverse protuberance intended to be engaged at one of the two ends of the tubular handle bar.

Another cart design is also known, for example, of the type described and represented in U.S. Pat. No. 5,613,696, the structure of which is formed essentially from plastic molded elements, but which presents characteristics common to those described above for attachment of the horizontal handle bar; namely, each side wall of the cart contains an upper upright or shaft, between which the handle extends.

Numerous solutions have been proposed for equipping such carts with accessories, notably, advertising displays which are visible to the user in the course of moving the cart in the store.

Such examples are illustrated, notably, by patents WO-A-96/30247, WO-A-96/11130, WO-A-98/05022, WO-A-03/057543, WO-A-05/052899, EP-A-1,582,432, U.S. Pat. No. 7,036,725 or also U.S. Pat. No. 5,320,443.

Among these patents, numerous solutions consist of a bracket capable of equipping the cart, the bracket containing a generally plate-shaped rear transverse platen, notably to comprise an advertising display, and containing two parallel vertical side flanges to support that rear platen and attach the bracket on the cart, each of which contains an opening that can be crossed by the handle bar.

Thus, once mounted on the cart, the two flanges supporting the bracket are crossed by the handle bar.

In patent WO-A-9630247, a first version is proposed, according to which the vertical side flanges are attached on the handle by means of tightening with screws. This solution has the disadvantage of occupying a part of the handle and of resorting to means of fastening that are unreliable over time.

Another solution proposed in that patent consists of replacing the existing means on a cart, resorting to a sleeve-shaped molded plastic assembly part for attachment of the handle with special parts that are extended for the support and attachment of the platen.

This solution makes it possible to disengage the entire length of the handle from the cart and to separate transversely the flanges supporting the platen, but it has the disadvantage of necessitating a considerable modification of all the existing carts one might desire to equip with the platen.

In order to remedy these disadvantages, the invention proposes a bracket capable of equipping a rolling cart, the cart being:
of the type containing two opposite side parallel side uprights oriented longitudinally, which extend globally upward and backward and between which there is a cylindrical transverse horizontal bar of circular section for movement of the cart by a user situated longitudinally behind the cart;
and of the type in which the upper end of each lateral upright is equipped with a generally convex assembly part, which receives the upper end of the corresponding upright and which contains a protuberance extending horizontally and transversely inward in order to cooperate with a free end of the tubular handle bar of the cart, the bracket being of the type containing:
   a transverse platen generally in the form of a plate globally extending horizontally, in proximity to the handle bar, notably to constitute an advertising display; and
   two parallel vertical side flanges for supporting the platen and attaching the bracket on the cart, each of which contains an opening capable of bring crossed by the handle bar,
      characterized in that each side flange contains:
a housing which has a shape complementing the outline of the associated part for assembly of the handle bar and which is open transversely toward the inside;
and a plate for closing the housing, which can be attached to the side flange in order to enclose the assembly part transversely in the housing and lock the side flange on the assembly part.

According to other characteristics of the invention:
the housing is delimited by a flat back side wall which extends longitudinally in a vertical plane and by a side wall which weds a convex complementary portion of the assembly part, and the closing plate is delimited by a flat side face which extends longitudinally in a vertical plane and by a concave rear end edge which weds a convex complementary portion of the assembly part;
the side wall contains a concave cylinder arc section that is appreciably coaxial to the handle bar, and the concave flat end edge contains a cylinder arc section that is appreciably coaxial to the handle bar;
the plate is delimited by two parallel and opposite side edges which are received between two parallel sections opposite the side wall, so that the closing plate is lodged inside the housing;
according to a first embodiment, the closing plate is attached on the side flange by means of at least one fastening rod which extends across the aligned complementary holes of the closing plate and associated side flange;
according to a second embodiment, the side wall contains a rim extending parallel to the flat back side wall of said housing, the said rim delimiting between it and the assembly part a space in which the closing plate can be engaged to close said housing;
the closing plate preferably contains on its face opposite the flat side face a center part which projects from the longitudinal edges of the plate, the closing plate being engageable in the space between the assembly part and the rim, said longitudinal edges being housed behind the rim, while the center part of the projecting plate is housed in the plane defined by the rim;
the closing plate preferably contains means of locking its engagement in the housing;
the housing is longitudinally open toward the front so as to permit the placement of the side flange on the assembly part by insertion of the assembly part in the housing in a longitudinal and vertical direction;
the plate is made in the form of a separate part which is attached between the free upper ends opposite the side flanges;
the platen, the side flanges and the closing plates are made by plastic molding;
the bracket makes possible a general symmetry of design relative to a longitudinal and vertical mid-plane;
the bracket contains a prop which can be inserted between the convex cylindrical wall of the handle bar and a center portion opposite the lower face of the platen.

Other characteristics and advantages of the invention, as well as details of design and construction, will be apparent on reading the detailed description which follows, for the understanding of which reference will be made to the attached drawings in which:

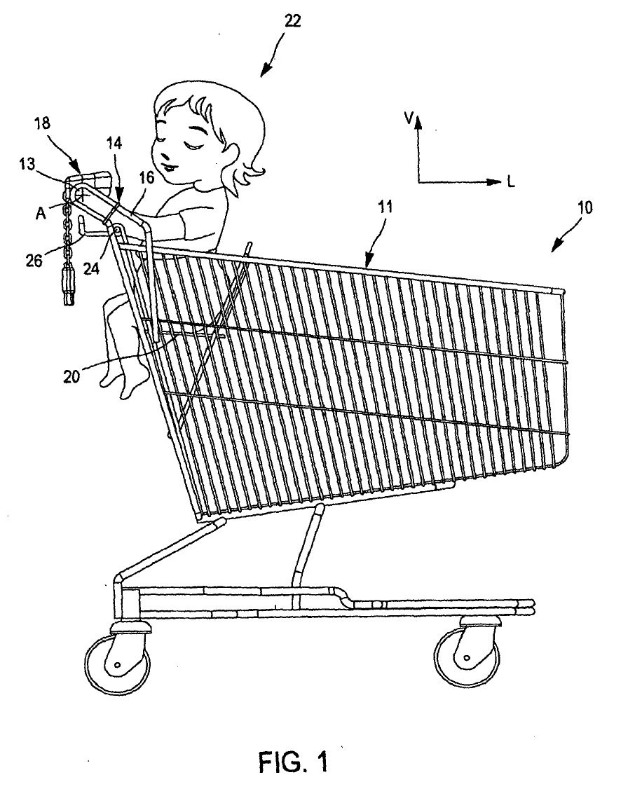

FIG. 1 is a side view in elevation of a rolling cart of a self-service store according to the state of the art;

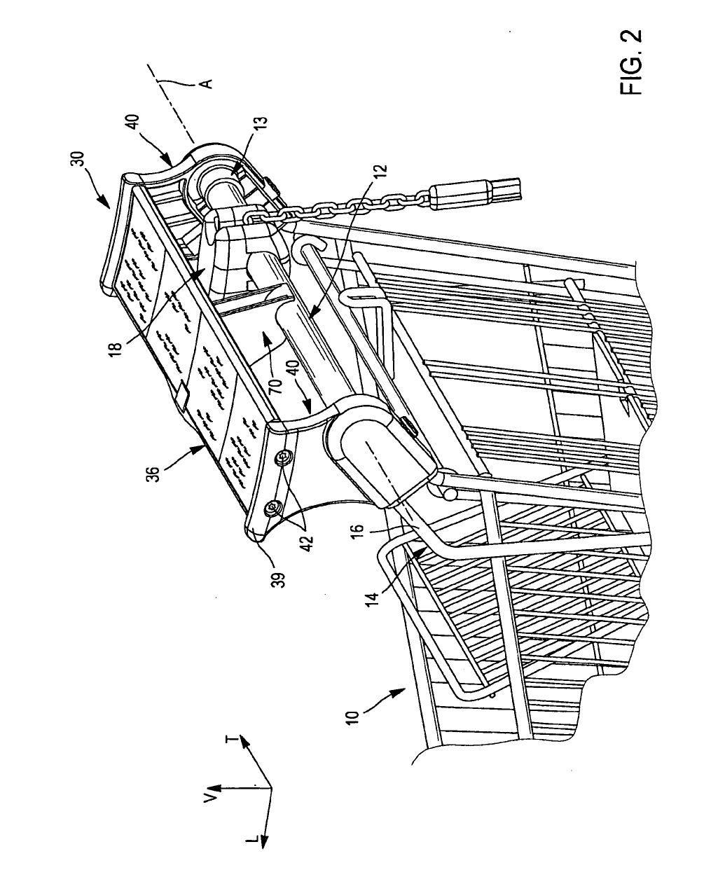

FIG. 2 is a view in perspective of the left rear three quarters of a cart of the type illustrated in FIG. 1 and which is equipped with a bracket according to the invention, all of the components of which are illustrated in assembled position;

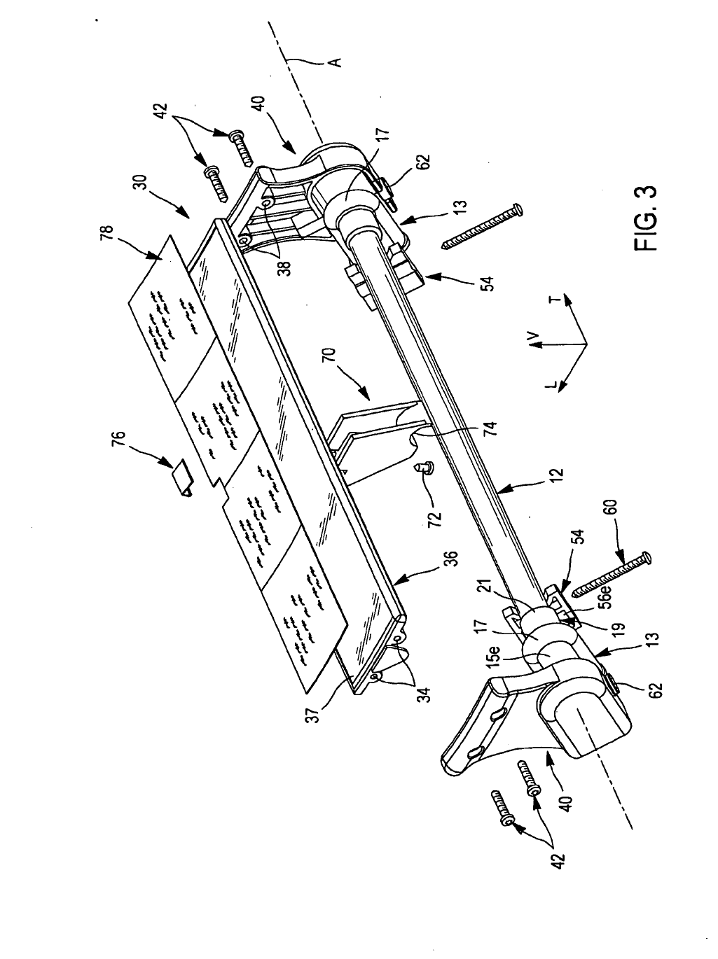

FIG. 3 is an exploded view in perspective of the left rear three quarters of the principal components of the cart and of the bracket of FIG. 2;

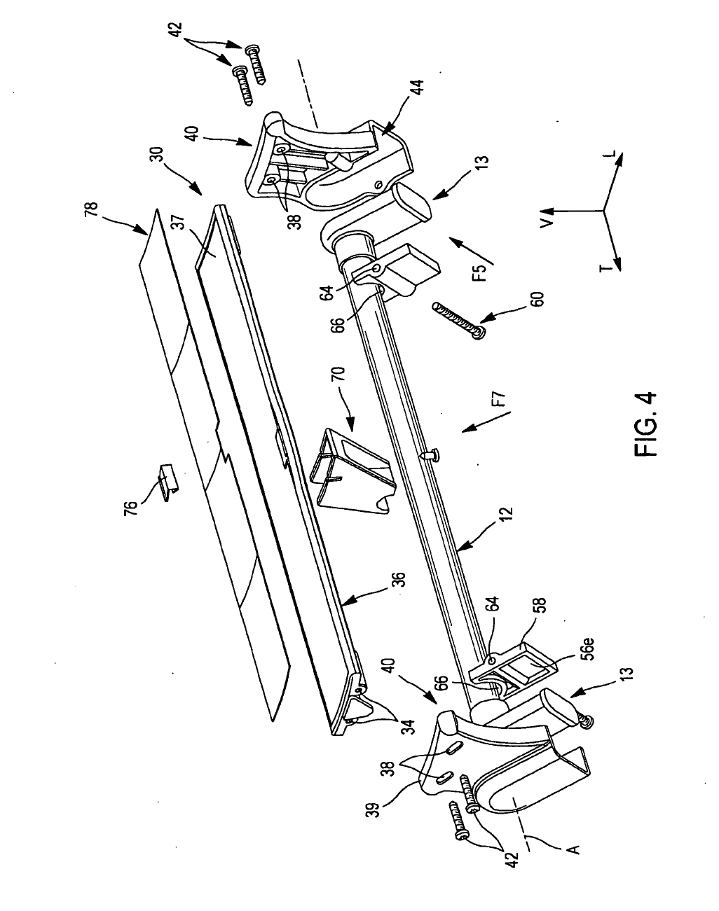

FIG. 4 is a view in perspective analogous to that of FIG. 3 at another angle of view;

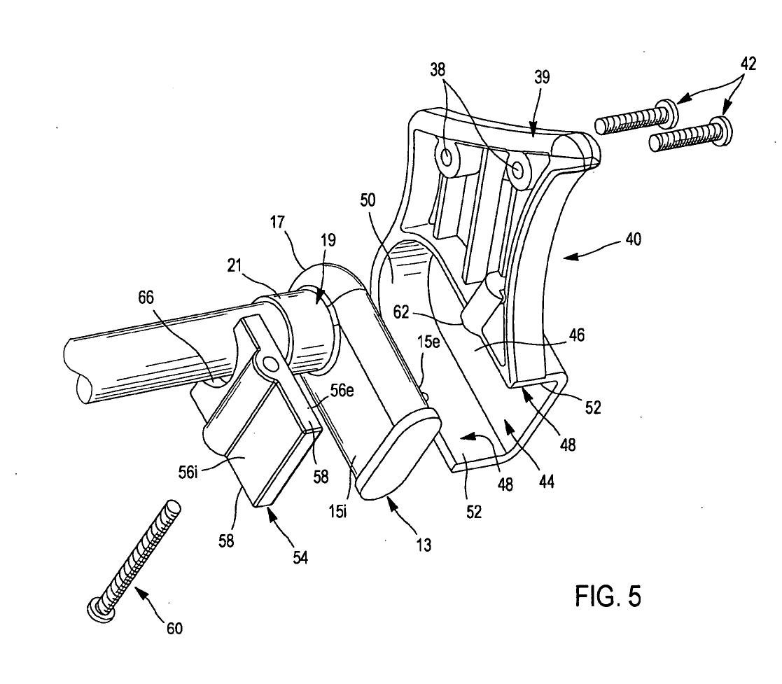

FIG. 5 is a detailed view on larger scale following arrow F5 of FIG. 4;

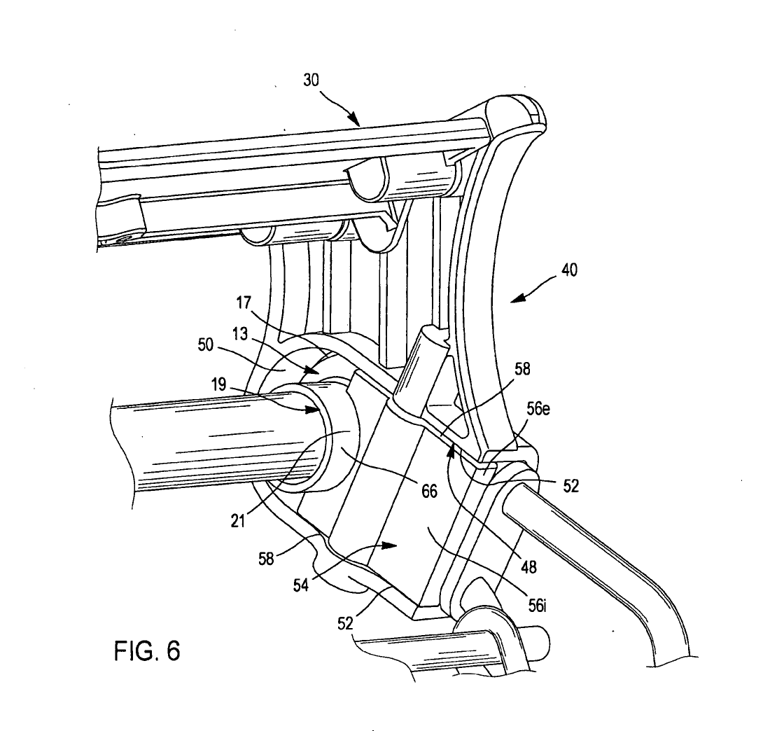

FIG. 6 is a view analogous to that of FIG. 5, illustrating the same components in assembly position and attached to one another;

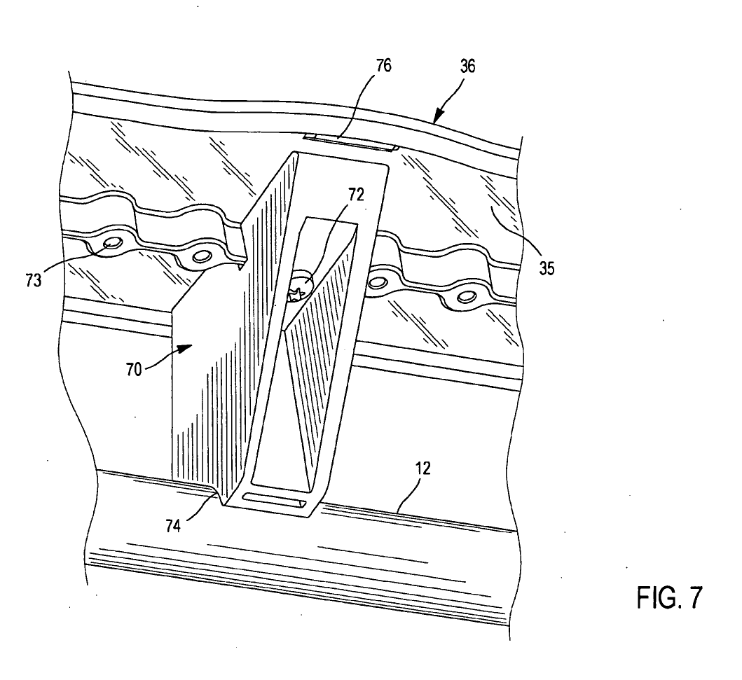

FIG. 7 is a detailed view on larger scale following arrow F7 of FIG. 2, which illustrates the prop in assembled position;

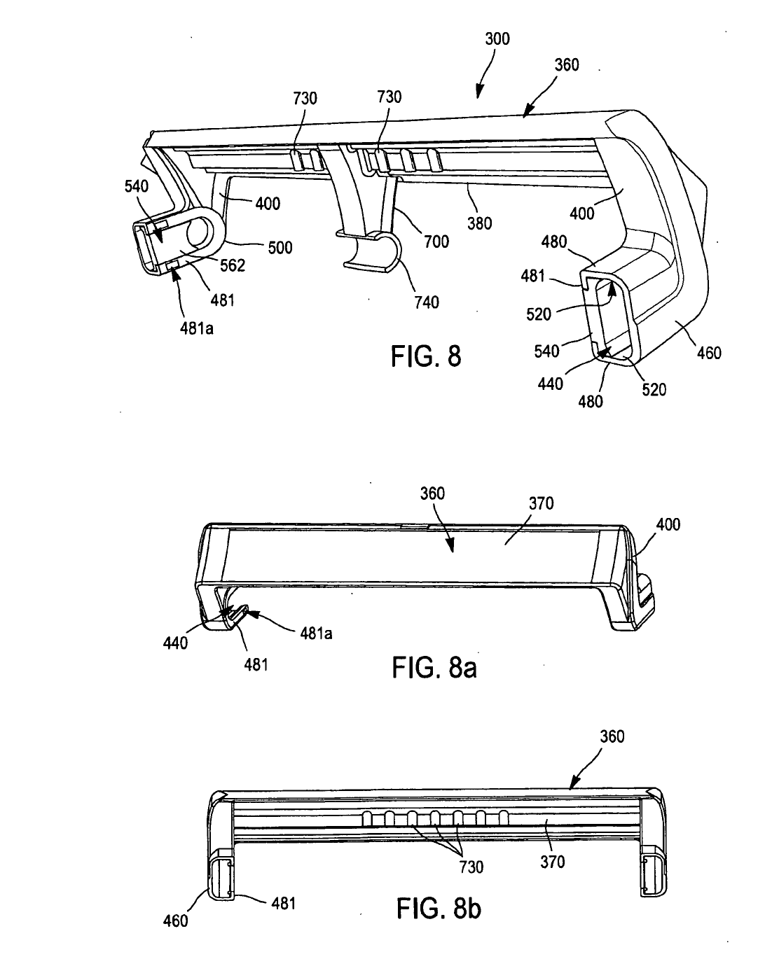

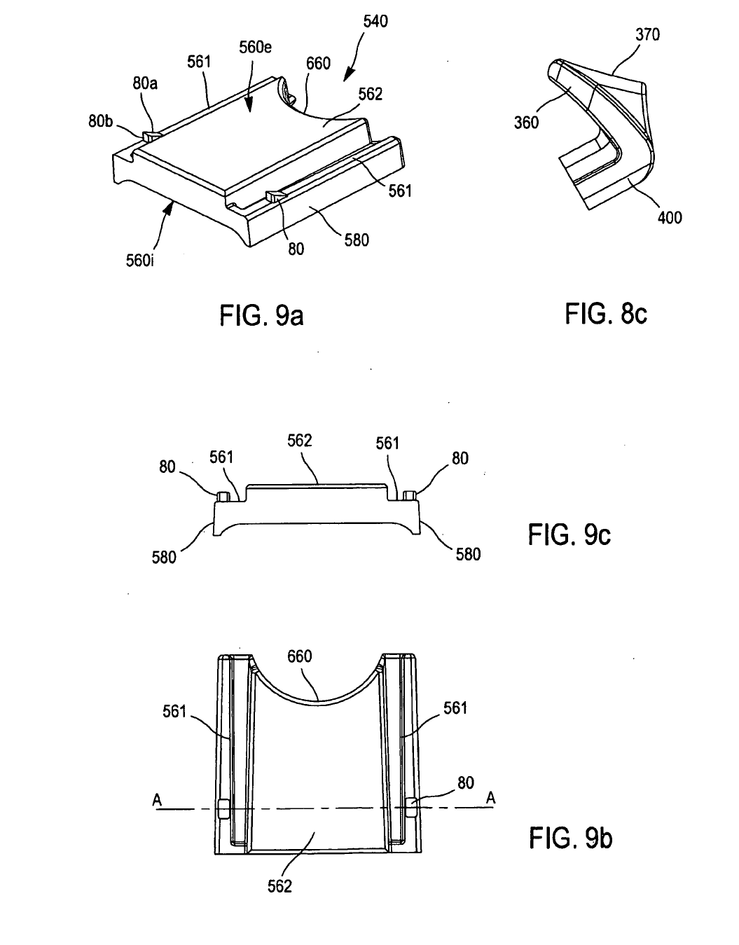

FIG. 8 represents a view in perspective of the right rear three quarters of a bracket according to a second embodiment of the invention, all of the components of which are illustrated in assembled position;

FIGS. 8a, 8b and 8c respectively represent a front view in perspective, a rear view in perspective and a side view in perspective of the bracket according to FIG. 8;

FIGS. 9a, 9b and 9c respectively represent a front view in perspective, a top view and a cutaway view along line A-A of the closing plate of the bracket represented in FIG. 8;

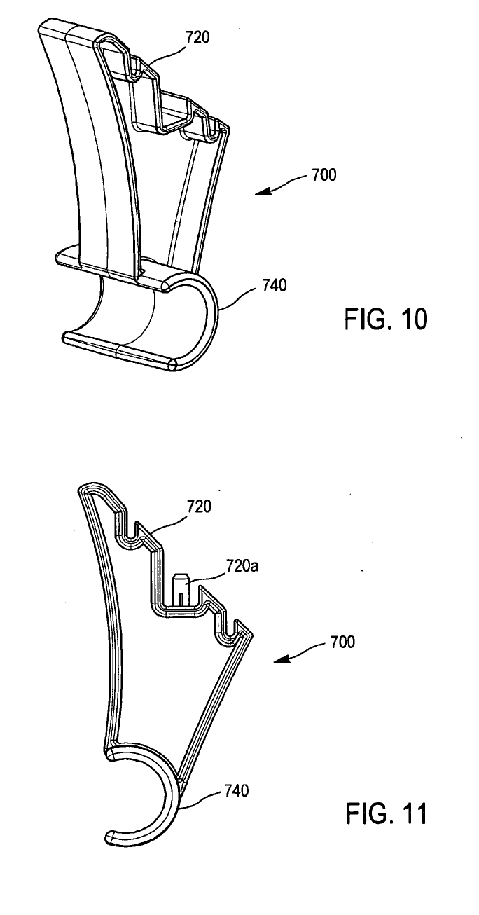

FIG. 10 represents a rear view in perspective of a prop for the bracket of FIG. 8;

FIG. 11 represents a side view in perspective of the prop of FIG. 10.

In the following description, identical, similar or analogous components or members will be designated by the same reference figures.

The terminology of vertical, horizontal, upper and lower will be adopted in reference to terrestrial gravity along with the terminology of longitudinal, vertical and transverse in reference to the trihedron L, V, T indicated in the figures, the longitudinal axis “L” being oriented by convention from back to front of the cart.

FIG. 1 represents a rolling cart 10 with a folded and welded wire structure containing at the rear in known manner a horizontal handle bar 12 of horizontal axis A, which is attached at the top of two opposite side uprights or shafts 14, each of which is made of a reverse U-shaped folded wire 16 and extends in a vertical plane.

The attachment of the bar 12 on the convex tops of the wire 16 uprights 14 is made here in known manner by means of two molded plastic assembly parts 13.

In known manner, the horizontal handle bar 12 serves as a support for a “coin” device 18.

In known manner, the rear portion of the basket 11 is equipped with a foldable seat 20 intended to accommodate a child 22.

A fixed horizontal upper rod 24 also bears, in known manner, a center hook 26.

The handle bar or grip 12 makes it possible to roll the cart 10 longitudinally from back to front, that is, from left to right, viewing FIG. 1, along axis L of the trihedron L, V, T.

With the exception of the coin device, the cart 10 has a general symmetry of design along a vertical mid-plane (not represented) containing axes L and V.

The horizontal axis A of the bar 12 is parallel to the transverse and horizontal axis T of the trihedron.

According to a known design, and as can be seen in greater detail, notably in FIGS. 5 and 6, each assembly part 13 is a generally convex part, plastic molded here, inside which the U-shaped free upper end 16 of the upright 14 extends and is attached.

The assembly part 13 is generally in the form of a sleeve which is delimited by two flat and vertical side faces, inner 15i and outer 15e, and by a convex toroidal arc upper wall 17.

At its upper end, from its inner side face 15i, the assembly part 13 contains at least one section 19 which extends transversely inward and cooperates with the free end section opposite the bar 12 for mounting and attaching the handle bar on the cart 10.

Section 19 is a section of convex cylindrical outline coaxial to the axis of the bar 12 and delimited by its peripheral surface 21.

The means of mounting and attaching the bar 12 of known design will not be described here in greater detail.

FIG. 2 and the following figures represent an embodiment of a bracket 30, which consists here essentially of a first upper part 36 and two lower flanges 40 that are parallel and each of which extends in a vertical plane.

The bracket 30 has a general symmetry of design relative to a longitudinal and vertical mid-plane.

These three main parts 36 and 40 are each made by plastic molding, and they are joined together to form the bracket 30 according to an assembly technique to be described below.

In the second embodiment represented in FIG. 8 and the following figures, the bracket 300 also consists essentially of an upper part 360 and of two lower flanges 400 which are parallel and each of which extends in a vertical plane. The bracket 300 has a general symmetry of design relative to a longitudinal and vertical mid-plane; however, the three main parts 360 and 400 are made in a single piece by plastic molding in order to constitute the bracket 300.

The bracket 30 thus contains an upper transverse platen 36 in the general form of a plate which globally extends horizontally with its free upper face 37 oriented upward and visible to the user, the upper platen 36 being vertically situated above and appreciably to the right of the bar 12 and its axis A.

Each flange 40 is a vertical side flange 40 of the bracket, which is a flange for both support of the upper platen 36 and attachment of the bracket 30 on the bar 12 of the cart 10.

The two vertical flanges 40 and the upper platen 36 are assembled together here by a set of two pairs of screws 42 which extend vertically horizontally and transversely inward, the screw shanks extending across the holes 38 formed for that purpose in the reinforced upper sections 39 of the side flanges 40 and their threaded ends being screwed into complementary holes 34 of the platen 36.

Each side flange 40 is generally in the form of a plate which extends in a vertical plane and which, in the assembled position and fixed position of the bracket on the cart, extends appreciably in the same plane as the associated upright 13.

In accordance with the invention, the side flanges 40 are designed to secure the mounting and attachment of the bracket 30 on the cart, without cooperating with the handle bar or grip 12 which retains its function.

The design according to the invention does not necessitate any modification of the existing cart for mounting and attachment of the bracket 30.

Each side flange 40 contains at its globally lower end a housing 44 which is made of molding material.

The shape and outline of the housing 44 are complementary with those of the assembly part 13.

The housing 44 is open transversely inward and vertically in the longitudinal direction and downward.

The housing 44 is delimited transversely outward by a flat bottom side wall 46 which extends longitudinally in a vertical plane and by a side wall 48 which weds the convex complementary portion of the assembly part 13.

The side wall 48 contains a rear upper section 50 appreciably in the form of a concave cylinder arc, coaxial with axis A of the handle bar 12.

The side wall 48 also contains two opposite flat parallel sections 52.

The depth in the transverse direction of the housing 44 is such that, in mounted position, the assembly part 13 is lodged entirely in the housing 44 (see FIG. 6) and that it is also possible to accommodate there a closing plate 54 of the housing 44.

The function of the plate 54 is to close the housing 44 transversely in order to confine the assembly part there.

The closing plate 54 is delimited by two parallel and opposite main faces, respectively inner 56i and outer 56e, each side face 56i and 56e being a flat face which extends longitudinally in a vertical plane.

The closing plate 54 is delimited by two parallel and opposite side edges 58 which can be received between the two flat parallel sections 52 of the housing 44 with a slight play, so that the closing plate 54 will be lodged inside the housing 44 (see FIG. 6).

The attachment of the closing plate on the side flange 40 is secured here by a screw 60 or by a force-fitted rod, the shank of which extends across complementary holes or bores 62 and 64 formed in the flange 40 and closing plate 54.

In order to immobilize the flange with its closing plate practically without play, relative to the assembly part 13, the closing plate 54 is delimited longitudinally upward and backward by a complementary convex portion of the assembly part.

More precisely, the closing plate 54 is delimited by a concave rear end edge 66 which weds a complementary convex portion of the convex peripheral surface 21 of section 19 of the assembly part 13.

By that cooperation and because section 50 weds the convex toroidal arc upper wall 17 also practically without play, the side flange is immobilized without play relative to the assembly part 13 and, therefore, relative to the upright 14.

If necessary, in order to reinforce the platen in its center portion, a plastic molded prop 70 is provided, which is inserted vertically between the lower face 35 of the platen 36 and the portion opposite the handle bar 12.

The prop 70 can be fastened to the platen 36 by a screw 72 in order to be integrated with the latter, the free lower end of the prop 70 containing an open recess 74 complementing the outline of the bar 12.

The prop 70 can, for example, be centered transversely, thus leaving free almost the entire length of the handle bar 12 so that it can be gripped by the user of the cart 10, and the bar 12 can, of course, also be freely equipped with a coin device.

The prop can also occupy a series of other positions by inserting the screw 72 in one of the holes 73 provided for that purpose. It is thus possible, for example, to place the prop according to the presence and position of a coin device on the cart to be equipped.

The upper face 37 of the rear platen 36 delimits, notably, an advertising space 80 capable of receiving, for example, a folder or a removable brochure 78 attached by means of a clip 76.

As a variant, the platen can constitute a support for an electronic display screen.

In the second embodiment represented in FIG. 8 and the following figures, the bracket 300 also consists essentially of an upper part 360 and of two lower flanges 400 which are parallel and each of which extends in a vertical plane. The bracket 300 has a general symmetry of design relative to a longitudinal and vertical mid-plane; however, the three main parts 360 and 400 are made in a single piece by plastic molding in order to constitute the bracket 300.

The bracket 300 thus contains an upper transverse platen 360 in the general form of a plate which globally extends horizontally with its free upper face 370 oriented upward and visible to the user, the upper platen 360 being vertically situated above and appreciably to the right of the bar 12 and its axis A.

Each flange 400 is a vertical side flange 400 of the bracket, which is a flange for both support if the upper platen 360 and attachment of the bracket 300 on the bar 12 of the cart 10.

The two vertical flanges 400 and the upper platen 360 are made here in a single piece by plastic molding in order to constitute the bracket 300. Reinforcing ribs 380 are provided under the lower face of the platen 360.

Each side flange 400 comes in the general form of a plate which extends in a vertical plane and which, in assembled and fixed position of the bracket on the cart, extends appreciably in the same plane as the associated upright 13.

In accordance with the invention, the side flanges 400 are designed to secure the mounting and attachment of the bracket 300 on the cart, without cooperating with the handle bar or grip 12 which retains its function.

The design according to this embodiment of the invention does not necessitate any change in the existing cart for mounting and attachment of the bracket 300.

Each side flange 400 contains at its globally lower end a housing 440 which is made of molding material.

The shape and outline of the housing 440 are complementary with those of the assembly part 13.

The housing 440 is open transversely inward and vertically in the longitudinal direction and downward.

The housing 440 is delimited transversely outward by a flat bottom side wall 460 which extends longitudinally in a vertical plane and by a side wall 480 which weds the convex complementary portion of the assembly part 13.

The side wall 480 contains a rear upper section 500 appreciably in the form of a concave cylinder arc, coaxial with axis A of the handle bar 12.

The side wall 480 also contains two opposite flat parallel sections 520.

The side wall 480 further contains a rim 481 extending perpendicular to said side wall 480 and appreciably in a plane parallel to the plane of the back wall 460.

The depth in the transverse direction of the housing 440 is such that, in mounted position, the assembly part 13 is lodged entirely in the housing 440 and that a space is provided between the rim 481 and the assembly part in which it is possible to accommodate a closing plate 540 of the housing 440.

The function of the plate 540, as previously described, is to close the housing 440 transversely in order to confine the assembly part 13 there.

The closing plate 540 is delimited by two parallel and opposite main faces, respectively inner 560i and outer 560e, appreciably extending longitudinally in a vertical plane.

The closing plate 540 is delimited by two parallel and opposite side edges 580 which can be received between the two flat parallel sections 520 of the housing 440 with a slight play, so that the closing plate 540 will be lodged inside the housing 440.

The attachment of the closing plate 540 on the side flange 400 is secured here by the engagement of said plate in the space provided between the assembly part 13 and the rim 481 of the side wall with a slight play.

In order to immobilize the flange 400 with its closing plate 540 practically without play relative to the assembly part 13, the closing plate 540 is delimited longitudinally upward and backward by a complementary convex portion of the assembly part 13.

More precisely, the closing plate 540 is delimited by a concave rear end edge 660 which weds a complementary convex portion of the convex peripheral surface 21 of section 19 of the assembly part 13.

By that cooperation and because section 500 weds the convex toroidal arc upper wall 17 also practically without play, the side flange 400 is immobilized without play relative to the assembly part 13 and, therefore, relative to the upright 14.

According to a preferred embodiment, the outer main face 560e, appreciably extending longitudinally in a vertical plane, has a center portion 562 of the outer face 560e projecting in relation to the longitudinal edges 561. The closing plate 540 is then engageable in the space between the assembly part 13 and the rim 481, the longitudinal edges 561 being housed behind the rim 481, while the center portion 562 complementing the shape of the rim 481 extends in the same vertical plane as said rim 481.

The inner face 560i of the closing plate 540 can, furthermore, be made slightly concave, so as to fit the assembly part 13 appropriately.

In order to engage the closing plate 540 in the housing 440, locking means can be provided, such as lugs 90 projecting at the longitudinal edges 56 of the closing plate 540, which can be fitted in complementary openings 481a provided in the rim 481.

These triangular lugs 90 have an inclined pitch 90a facilitating engagement of the closing plate 540 in the housing 440 between the assembly part 13 and the rim 481. The inclined pitch 90a is then continued by a vertical wall 90b intended to abut the edge of the opening 481a once the closing plate 540 is lodged in the housing 440, so that this abutment of the lug 90 prevents unlocking of the closing plate 540.

In order to reinforce the platen 360 in its center portion, a plastic molded prop 700 can be provided, which is vertically inserted between the lower face 350 of the platen 360 and the portion opposite the handle bar 12.

The prop 700 can be fastened to the platen 360 by a molded lug 720a in order to be integrated with the latter, the free lower end of the prop 700 containing an open tubular portion 740 complementing the outline of the bar 12. Such tubular portion 740 hugs the bar 12 and makes it possible to maintain the bracket on the cart more securely. The upper part 720 of the prop 700 has an outline complementing that of the lower face of the platen 360.

The prop 700 can, for example, be centered transversely, thus leaving free almost the entire length of the handle bar 12 so that it can be gripped by the user of the cart 10, and the bar 12 can, of course, also be freely equipped with a coin device.

The prop 700 can also occupy a series of other positions by inserting the lug 720a in one of the holes 730 provided for that purpose. It is thus possible, for example, to place the prop according to the presence and position of a coin device on the cart to be equipped.

The upper face 370 of the rear platen 360 delimits, notably, the advertising space 80 capable of receiving, for example, a folder or a removable brochure 78 attached by means of a clip 76, as previously seen.

1. A bracket capable of equipping a rolling cart, the cart being
of the type containing two spaced-apart parallel side uprights, which extend upward and backward and between which there is a cylindrical transverse horizontal bar of circular section for movement of the cart;
and of the type in which an upper end of each upright is equipped with a generally convex assembly part, which receives the upper end of the corresponding upright and which contains a protuberance extending horizontally and transversely inward in order to cooperate with a free end of the horizontal bar of the cart,
the bracket being of the type containing:
a transverse platen generally in the form of a plate extending horizontally, in proximity to the horizontal bar notably to constitute an advertising display; and
two parallel vertical side flanges for supporting the platen and attaching the bracket on the cart, each of which contains an opening capable of being crossed by the horizontal bar,
characterized in that each side flange contains:
a housing which has a shape complementing the outline of the associated part for assembly of the horizontal bar and which is open transversely toward the inside;
and a plate for closing said housing, which can be attached to the side flange in order to enclose the assembly part transversely in said housing and lock the side flange on said assembly part.

2. The bracket according to claim 1, wherein the housing is delimited by a flat back side wall which extends longitudinally in a vertical plane and by a side wall which weds a convex complementary portion of said assembly part, and in that said closing plate is delimited by a flat side face which extends longitudinally in a vertical plane and by a concave rear end edge which weds a convex complementary portion of said assembly part.

3. The bracket according to claim 2, wherein the side wall contains a concave cylinder arc section that is appreciably coaxial to said horizontal bar, and in that said concave flat end edge contains a cylinder arc section that is appreciably coaxial to said horizontal bar.

4. The bracket according to claim 2, characterized in that the said plate is delimited by two parallel and opposite side edges which are received between two parallel sections opposite said side wall, so that the closing plate is lodged inside said housing.

5. The bracket according to claim 1, wherein the closing plate is attached on the side flange by means of at least one fastening rod which extends across aligned complementary holes of the closing plate and associated side flange.

6. The bracket according to claim 2, wherein the side wall contains a rim extending parallel to the flat back side wall of said housing, the said rim delimiting between it and the assembly part a space in which the closing plate can be engaged to close said housing.

7. The bracket according to claim 6, wherein the closing plate contains on its flat side face a center part which projects from the longitudinal edges of said side face, the closing plate being engageable in the space between the assembly part and the rim, said longitudinal edges being housed behind the rim, while the center part of the projecting plate is housed in the space defined by the rim in the same plane as the latter.

8. The bracket according to claim 6, wherein the closing plate contains means of locking its engagement in the housing, such as lugs projecting at the longitudinal edges of the closing plate, which can be fitted in complementary openings provided on the rim.

9. The bracket according to claim 1, wherein the housing is longitudinally open toward the front so as to permit the placement of the side flange on said assembly part by insertion of said assembly part in the housing in a longitudinal and vertical direction.

10. The bracket according to claim 1, wherein the plate is made in the form of a separate part which is attached between free upper ends opposite the side flanges.

11. The bracket according to claim 1, wherein the platen, the side flanges and the closing plates are made by plastic molding.

12. The bracket according to claim 1, wherein the bracket has a general symmetry of design relative to a longitudinal and vertical mid-plane.

13. The bracket according to claim 1, wherein the two vertical flanges and the upper plate are made in a single piece by plastic molding in order to form the bracket.

14. The bracket according to claim 1, wherein it contains a prop which can be inserted between the convex cylindrical wall of the horizontal bar and a center portion opposite the lower face of the platen.
